(19) United States
(12) Patent Application Publication
(10) Pub. No.: US 2009/0209224 A1
(43) Pub. Date: Aug. 20, 2009

(54) Computer-Related Devices and Techniques for Facilitating an Emergency Call Via a Cellular or Data Network

(76) Inventors: Daniel M. Borislow, Palm Beach, FL (US); Gregory Lynn Wood, Oneonta, AL (US)

Correspondence Address: ARNOLD & PORTER LLP;ATTN: IP DOCKETING DEPT., 555 TWELFTH STREET, N.W., WASHINGTON, DC, 20004-1206, US

(21) Appl. No.: 12/034,569

(22) Filed: Feb. 20, 2008

(51) Int. Cl. H04M 11/04

(52) U.S. Cl. 455/404.1

(57) ABSTRACT

The claimed invention consists of a device for use with a computer. The device may include control logic that receives a first signal corresponding to an emergency call and implements the emergency call as either a cellular-based call or a VoIP call. If two-way communication can be established with a remote device via a cellular network, then the emergency call is implemented as a cellular-based call via the cellular network. If two-way communication cannot be established with a remote device, then the emergency call is implemented as a VoIP call.

### FIELD OF THE INVENTION

This invention is applicable at least in the fields of voice and data communications (e.g., those that implement Voice over Internet Protocol (VoIP) communications) and the field of cellular telephony and, more particularly, in the field of devices, systems, processor program products, and methods of facilitating emergency calls. The invention may be applicable, for example, in systems interfacing a standard telephone to a data network (e.g., a VoIP compatible communication network) via, for example, a computer system, which may facilitate communication over the data network via, for example, a local area network, wide area network, and/or over an existing wireless network.

### BACKGROUND OF THE INVENTION

VoIP is a technology that allows the systems and transmission channels that connect computer networks to act as an alternative to phone lines, delivering real-time voice to both standard telephones and personal computers (PCs). VoIP allows an individual to utilize a network connection to transmit voice encapsulated data packets over available local communication lines, such as the Internet. This is typically facilitated by the use of an Analog Telephone Adapter (ATA) which emulates some functions of a phone company's central office and connects via a wired interface to a network like the Internet.

In a VoIP system, the analog voice signal is typically picked up by a microphone and sent to an audio processor within a personal computer. In the computer, either a software or hardware CODEC performs analog-to-digital conversion and compression. Considerable research has been devoted to voice compression schemes that are well know to those skilled in the art. The nominal bandwidth required for telephone-type voice ranges from 2.9 Kbps (RT24 by Voxware) to 13 Kbps (GSM cellular standard).

In placing the CODEC output into packets, there is a trade-off between bandwidth and latency. CODECs do not operate continuously. Instead, they sample the voice over a short period of time, known as a frame. These frames are like little bursts of data. One or more frames can be placed in a single IP datagram or packet, and then the packet payload is wrapped in the necessary packet headers and trailers. This packet overhead is at least 20 bytes for IP and 8 bytes for the User Datagram Protocol (UDP). Layer 2 protocols add even more overhead. Waiting longer to fill the IP datagram reduces overall overhead, which in turn reduces the true bandwidth needed to send the digitized voice. However, this waiting creates latency at the source, and too much total latency makes for a difficult conversation.

The total network latency and jitter (changes in the latency) have a degrading effect upon voice quality. Therefore, real-time voice quality is difficult to maintain over a large wide-area packet network without priority handling. As previously mentioned, VoIP converts standard telephone voice signals into compressed data packets that can be sent locally over an Ethernet or globally via an ISP's data networks rather than traditional phone lines. One of the main difficulties with VoIP connections is that the communication network supporting a VoIP platform must be able to recognize that VoIP data packets contain voice signals, and be “smart” enough to know that the communication network has to move the data packets quickly.

Presently, much of the VoIP voice traffic does not use the public Internet but runs on private IP-based global networks that can deliver voice data with minimal congestion. As such, transmission of voice signals over private data networks offers businesses some great advantages. For ISPs, merging voice and data on one single network allows them to expand their services beyond simple information access and into the realm of voice, fax, and virtual private networking. For businesses, the benefit is big savings on long-distance service. The Internet right now is a free medium on many networks. If businesses can send voice over a computer network, businesses can conceivably make long-distance or international calls for the cost of a local call. VoIP further facilitates electronic commerce by allowing a customer service representative using one data line to answer telephone questions while simultaneously placing a customer's order online, perusing the company's web site, browsing an online information/product database, or sending an e-mail. Similarly, VoIP also creates new possibilities for remote workers, who for the cost of a local call can log in remotely, retrieve voice mail from their laptop PCs, and keep their E-mail and web applications running while conducting multiple voice and data calls over one phone line. Presently, this type of expanded VoIP functionality is often exclusively limited to those with access to private IP based networks, such as business users and not the typical household user.

In fact, most household computer users are generally limited to the congested public Internet and cannot implement the VoIP standard as effectively as those with private IP based networks. If latency and jitter are too high, or the cost of reducing them is excessive, one alternative is to buffer the CODEC data at the receiver. A large buffer can be filled irregularly but emptied at a uniform rate. This permits good quality reproduction of voice. Such a buffering technique is known as audio streaming, and it is a very practical approach for recorded voice or audio. Unfortunately, excessive buffering of the audio signals leads to generally unacceptable one-sided telephone conversations, where one party dominates the transmissions.

Traditionally, the operating environment for a household user with a VoIP connection is either a laptop or desktop general-purpose computer. The recording and transmission or interpretation of the VoIP packets takes place in the sound system or modem DSP found on the laptop or desktop. As such, the desktop system has a minor advantage over the laptop, because the desktop sound system traditionally provides stereo surround speakers and an accurate microphone. Thus, the desktop system can more accurately capture an individual's voice for retransmission of these voice signals to the user on the other end of the connection. VoIP telephone software buffering and control structures help improve the connection, but even though the audio signal has been accurately sampled, the processor delays and transmission latency associated with the desktop VoIP connection over the public Internet may at times result in a barely audible VoIP call.

One of the main difficulties with using VoIP is that it is difficult to facilitate the handling of emergency calls, e.g., emergency “911” calls via systems that implement a VoIP connection. This is especially true when VoIP connections are initiated from mobile or nomadic devices. The present invention solves these and other problems involved in the current state of the art, as will be explained below.

### SUMMARY OF THE INVENTION

The present invention is best understood with reference to the claims, the entire specification, and all of the drawings submitted herewith, which describe the devices, systems, processor program products and methods of the present invention in greater detail than this summary, which is merely intended to convey aspects of illustrative embodiments of the present invention. By way of example, the disclosed devices (e.g., computers and adapters, such as network adapters), systems, processor program products and methods may include a combination of hardware and/or software which allows the user to overcome problems associated with making emergency calls on a VoIP communications network. Also by way of example, the central processing unit(s), processor(s), controller(s) or control logic in the disclosed devices (e.g., the computers and adapters) can include the ability to route, via a transceiver for example, emergency calls to a commercial mobile radio service (“CMRS” or cellular) transmitter over a CMRS network to facilitate the handling of emergency calls, such as emergency “911” calls. If a transmission is not possible, or is attempted and fails for any reason, then, in accordance with the present invention, the emergency call will be placed over the VoIP network. By way of example, if the system cannot detect a cellular signal, or if a cellular signal is detected but transmission of the call over the cellular network fails, then the emergency call will be placed over the VoIP network.

The systems and methods disclosed herein also allow the devices (e.g., the computers and adapters) to connect to a wireless network and thereby to a VoIP carrier via a signaling protocol. Thus, additional freedom and functionality are provided to the user, as described in more detail below.

Optionally, the adapter devices can also be configured to transmit information over a broadband cellular link, such as EV-DO or other similar types of networks.

Additional objects, advantages and novel features of this invention will be set forth in part in the description that follows, and in part will become apparent to those skilled in the art upon examination of the following description, or may be learned by practicing the invention.

### BRIEF DESCRIPTION OF THE DRAWINGS

In the accompanying drawings that form a part of the specification and are to be read in conjunction therewith, the present invention is illustrated by way of example and not limitation, with like reference numerals referring to like elements, wherein:

FIGS. 1(a) and 1(b) illustrate an adapter, according to an embodiment of the invention;

FIG. 2 illustrates a communications network, according to an embodiment of the invention;

FIG. 3 is a flow chart illustrating the process of making an emergency call, according to an embodiment of the invention;

FIGS. 4(a) and 4(b) illustrate a communications network, according to embodiments of the invention;

FIG. 5 is a flow chart illustrating the process of making an emergency call, according to an embodiment of the invention;

FIG. 6 illustrates a computer system, according to an embodiment of the invention;

FIG. 7 is a flow chart illustrating the process of making an emergency call, according to embodiments of the invention; and

FIG. 8 is a flow chart illustrating the process of making an emergency call, according to an embodiment of the invention.

### DETAILED DESCRIPTION OF THE INVENTION

In the following detailed description, numerous specific details are set forth in order to provide a thorough understanding of the invention. In other instances, well known structures, interfaces, and processes have not been shown in detail in order not to unnecessarily obscure the invention. However, it will be apparent to one of ordinary skill in the art that those specific details disclosed herein need not be used to practice the invention and do not represent a limitation on the scope of the invention, except as recited in the claims. It is intended that no part of this specification be construed to effect a disavowal of any part of the full scope of the invention.

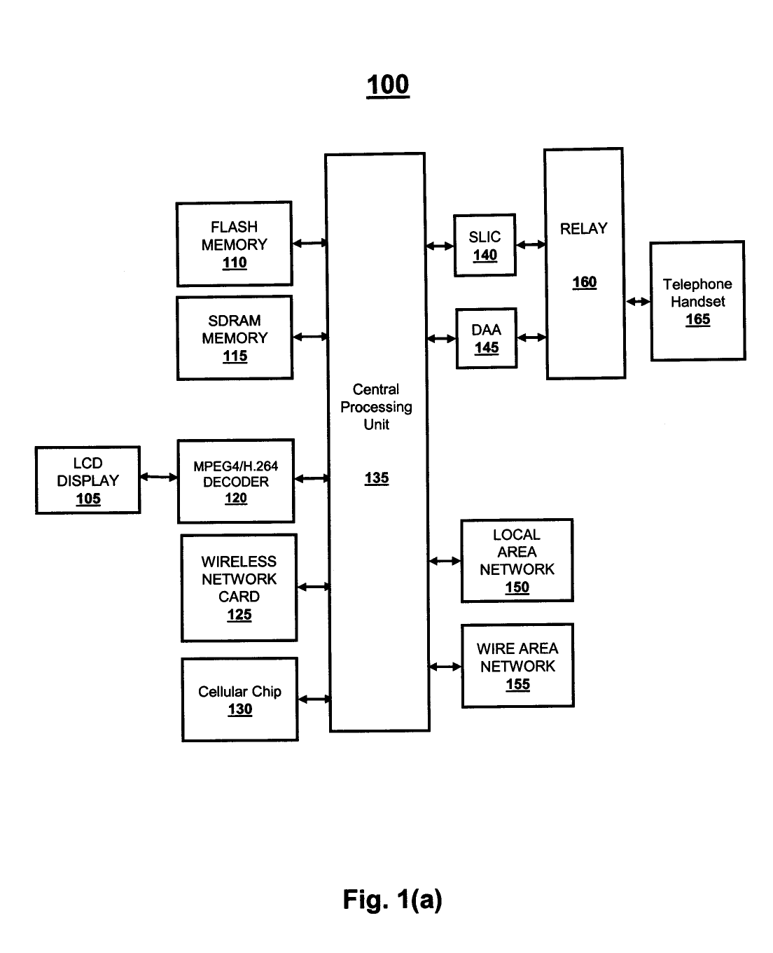

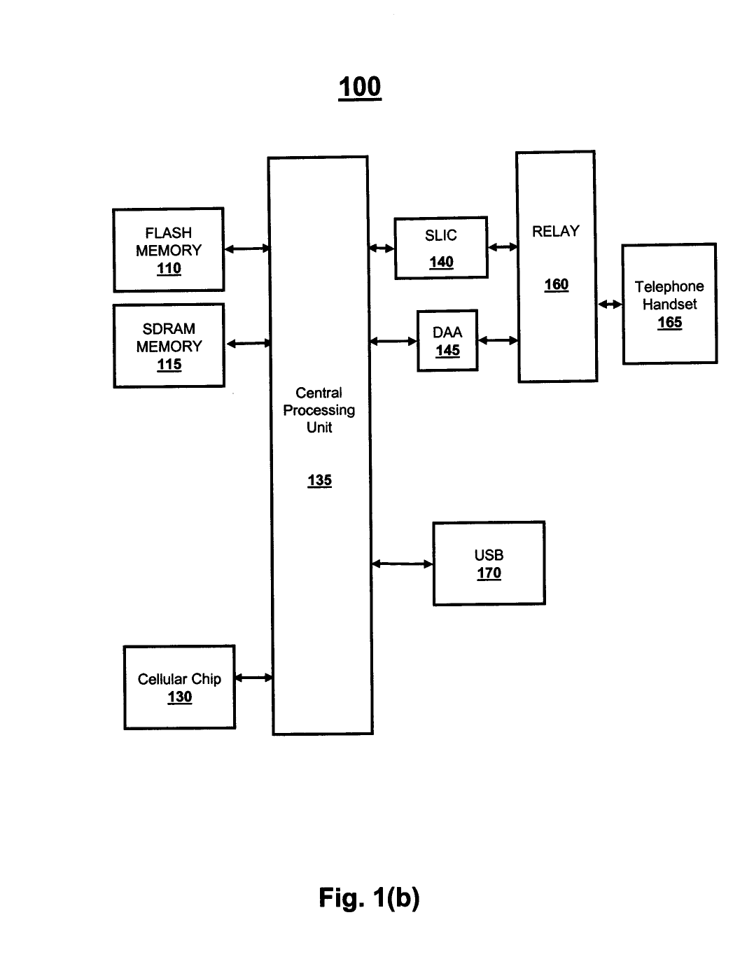

FIG. 1(a) illustrates the components of a particular device, which is an adapter 100, such as a network adapter, according to an embodiment of the invention. However, these components may be employed in a number of other systems and devices of the present invention. By way of the example, the components described in connection with the adapter 100 and the manner in which they are employed may be the same for other devices, including telephones (e.g., cellular phones) and computers. Accordingly, the description of the adapter 100 set forth herein and reflected in the drawings may be read more broadly as merely an example of the types of features that other devices, such as telephones and computers, may have that implement the present invention. In some instances, the components of the adapter may be incorporated in a computer, and so no separate adapter may be required.

The adapter 100 includes a central processing unit 135 connected to the relay 160 via the subscriber line interface (SLIC) 140 and the DAA 145. The relay 160 is used to isolate and bridge an analog telephone handset (165) to the adapter 100. In some instances, a digital telephone handset may be employed. In addition, a separate handset may not be required if a headset, microphone, and/or speakers of a computer are employed.

As stated above, the adapter 100 includes a SLIC 140 and a data access arrangement (DAA) circuit 145. The SLIC 140 is responsible for emulating a central office. It generates a ring current, detects on-hook and off-hook transition and notifies the central processing unit (CPU) 135 of any signal transition. The SLIC 140 also performs A/D conversion on input voice signal and may also perform D/A conversion on voice signal to be processed by the telephone handset (165). The DAA 145 detects a ring current and notifies the CPU 135 of the presence of a ring current. The DAA 145 also creates off-hook and on-hook transactions in order to emulate a telephone handset back to the phone company's central office, and it also performs A/D and/or D/A conversion on signals transmitting to and from the equivalent of a central office (not shown).

The CPU 135 controls the adapter 100 via programmable software. The CPU 135 is a microprocessor, of a kind that is well known to one of ordinary skill in the art. Integrated into the CPU 135 is digital signal processor software (not shown) which processes voice signal data in real time.

Connected to the CPU 135 are several memory devices such as flash memory 110 and SDRAM 115. The flash memory 110 may be used to store information permanently, such as configuration information and program code, when the adapter 100 is turned off. The SDRAM 115 may be used as a working storage for the CPU 135 during operation.

The MPEG-4/H.264 decoder 120 is an integrated circuit that is responsible for producing video output from the CPU 135 to the optional LCD display 105. The MPEG-4/H.264 decoder 120 decodes streaming video information received via the wide area network connection 155 via the CPU 135. One of ordinary skill in the art can appreciate that any kind of decoder, such as, for example, an MPEG-4/H.264 decoder, can be used to decode the video output, if any.

The LCD display 105, which is an optional feature of the adapter 100, is used to display information about the incoming call and diagnostic and status information of the adapter 100. The LCD display 105 can also be used to display and present advertising and/or entertainment to the user. In an alternative embodiment of the invention, the CPU 135 includes circuitry which monitors the signal strength of the wireless network (not shown) employed by the adapter 100. The signal strength monitoring circuitry is well known to one of ordinary skill in the art. The MPEG-4/H.264 decoder 120 receives this information from the CPU 135 in real-time and transfers this information to the LCD display 105. The LCD display 105 receives the signal strength information and displays it to the user in a known manner. Accordingly, the user can monitor the signal strength as displayed on the LCD display 105 and manually adjust the location of the adapter 100 in order to maximize the signal strength. In further embodiments, the LCD display 105 can show information regarding the strength of the cellular network that is received from CPU 135. In one embodiment, the LCD display 105 can show the signal strength of the cellular network.

In one embodiment, a wireless network card 125 is connected to the CPU 135. The wireless network card 125 may be connected to the CPU 135 via a mini-PCI connector (not shown). Also, the wireless network capability may be built in to the adapter 100 in the form of a semiconductor chip without the use of a separate card. The wireless network card 125 allows the adapter 100 to access any one of available wireless networks. The wireless network card 125 can transmit the information to the network by implementing a variation of the IEEE 802.11 standard. One of ordinary skill, however, can appreciate that other methods can be employed as well. The wireless network card 125 is built into the adapter 100 via a replaceable module via a known standard such as PCI, PCMCIA, or USB. By employing a particular wireless card, a user can have access to any number of wireless networks such as Wi-Fi, Wi-Max, EV-DO, HSPDA, and any other wireless network for which a mini-PCI card has been developed.

One of ordinary skill in the art can appreciate that the adapter 100 requires AC or DC power in order to operate. By way of example and not limitation, the adapter can be powered from an AC electrical outlet or DC power source, such as the cigarette lighter in an automobile, a DC battery, or the USB port of a computer.

In yet another embodiment of the invention, the adapter 100 can be adapted to include multiple wireless network cards. The multiple wireless network cards feature would allow the user flexibility to employ different types of wireless network services, such as Wi-Fi and cellular broadband wireless. One of ordinary skill can appreciate that many different services can be employed and the example is used for illustration and not as a way of limitation. The circuitry would be adapted to include a mini-PCI card and another mini-PCI card or other replaceable module, such as PCMCIA, USB or PCI. The CPU 135 would include software which would allow the network interface to adaptively switch between using the wireless network cards to transmit a voice signal and allow a user to replace wireless network cards during the operation of the adapter 100. For example, when the adapter 100 is not in range of the router 235 via Wi-Fi or other wireless network, the adapter 100 would transmit the packetized voice signal from the phone via a broadband cellular network like EV-DO or another applicable cellular broadband network to which the user has a subscription:

The adapter 100 has the capability to be attached to a local area network 150 to communicate with users on laptop or desktop personal computers and a wide area/broadband network 155 for communicating over a packet switched network, such as the Internet. Typically, the adapter has one or more RJ-11 jacks to connect with a telephone, and at least one RJ-45 connection to a 10/100BaseT Ethernet Hub or switch to connect to the local area network 150. Alternatively, the adapter 100 may be attached directly to a laptop or desktop personal computer via, for example, a USB connection.

Also connected to the CPU 135 is a cellular chip 130 implementing a transceiver which allows the adapter 100 to access a cellular network. The cellular chip 130 may be connected to the CPU 135 or it may be integrated with the CPU 135 on a circuit (with or without other components). The cellular chip 130 receives voice data from the CPU 135 and modulates and transmits the data in a known way to communicate with another user via the cellular network. The cellular chip 130 functions in a duplex manner to allow voice conversations over the cellular network. In an embodiment of the invention, the CPU 135 may execute software that routes emergency calls to the cellular chip 130 which establishes a two-way communication channel corresponding to the emergency call, the two-way communication channel being established over a cellular network. Specifically, in one embodiment, if the CPU 135 determines that the cellular chip 130 can engage in two-way communication via the cellular network, then the CPU 135 proceeds to route the call over a cellular network via the cellular chip. By way of example, the CPU 135 may determine that the cellular chip 130 can engage in two-way communication via the cellular network by determining if a cellular signal is present. In an alternative embodiment, the CPU 135 may determine that the cellular chip 130 can engage in two-way communication via the cellular network by measuring the strength of a cellular signal and comparing it to a pre-determined standard. If the CPU determines that the cellular chip 130 can not engage in two-way communication via the cellular network, then the CPU 135 proceeds to route the call over the VoIP network. In another embodiment, the CPU attempts to route the call over a cellular network, and if the attempt fails, then the CPU 135 proceeds to route the call over the VoIP network, via, for example, a router and/or broadband modem.

FIG. 1(b) illustrates one example of the components of a device, which is an adapter 100, such as a network adapter, according to a preferred embodiment of the invention. Again, these components may be employed in a number of other systems and devices of the present invention.

The adapter 100 includes a central processing unit 135 connected to the relay 160 via subscriber line interface (SLIC) 140 and the DAA 145. The relay 160 is used to isolate and bridge an analog telephone handset (165) to the adaptor 100. In some instances, a digital telephone handset may be employed. In addition, a separate handset may not be required if a headset, microphone, and/or speakers of a computer are employed.

The adapter 100 includes a subscriber line interface (SLIC) 140 and a data access arrangement (DAA) circuit 145. The SLIC 140 is responsible for emulating a central office. It generates a ring current, detects on-hook and off-hook transition and notifies the central processing unit (CPU) 135 of any signal transition. The SLIC 140 also performs A/D conversion on input voice signal and may also perform D/A conversion on voice signal to be processed by the telephone handset (165). The DAA 145 detects a ring current and notifies the CPU 135 of the presence of a ring current. The DAA 145 also creates off-hook and on-hook transactions in order to emulate a telephone handset back to the phone company's central office, and it also performs A/D and/or D/A conversion on signals transmitting to and from the equivalent of a central office (not shown).

The CPU 135 controls the adapter 100 via programmable software. The CPU 135 is a microprocessor, of a kind that is well known to one of ordinary skill in the art. Integrated into the CPU 135 is digital signal processor software (not shown) which processes voice signal data in real time.

Connected to the CPU 135 are several memory devices, such as flash memory 110 and SDRAM 115. The flash memory 110 may be used to store information permanently, such as configuration information and program code, when the adapter 100 is turned off. The SDRAM 115 may be used as a working storage for the CPU 135 during operation. The adapter 100 may have the capability to be attached directly to a laptop or desktop personal computer via a USB connector 170.

Also connected to the CPU 135 is a cellular chip 130 implementing a transceiver which allows the adapter 100 to access a cellular network. The cellular chip 130 may be connected to the CPU 135 or it may be integrated with the CPU 135 on a circuit (with or without other components). The cellular chip 130 receives voice data from the CPU 135 and modulates and transmits the data in a known way to communicate with another user via the cellular network. The cellular chip 130 functions in a duplex manner to allow voice conversations over the cellular network. In an embodiment of the invention, the CPU 135 may execute software that routes emergency calls to the cellular chip 130 which establishes a two-way communication channel corresponding to the emergency call, the two-way communication channel being established over a cellular network. Specifically, if the transceiver detects the presence of a cellular network, then the CPU 135 attempts to route the call over the cellular network. If not, then the CPU 135 proceeds to route the call over the VoIP network. If the transceiver detects the presence of a cellular network, but the attempt to route the call over the cellular network fails, then the CPU 135 proceeds to route the call over the VoIP network.

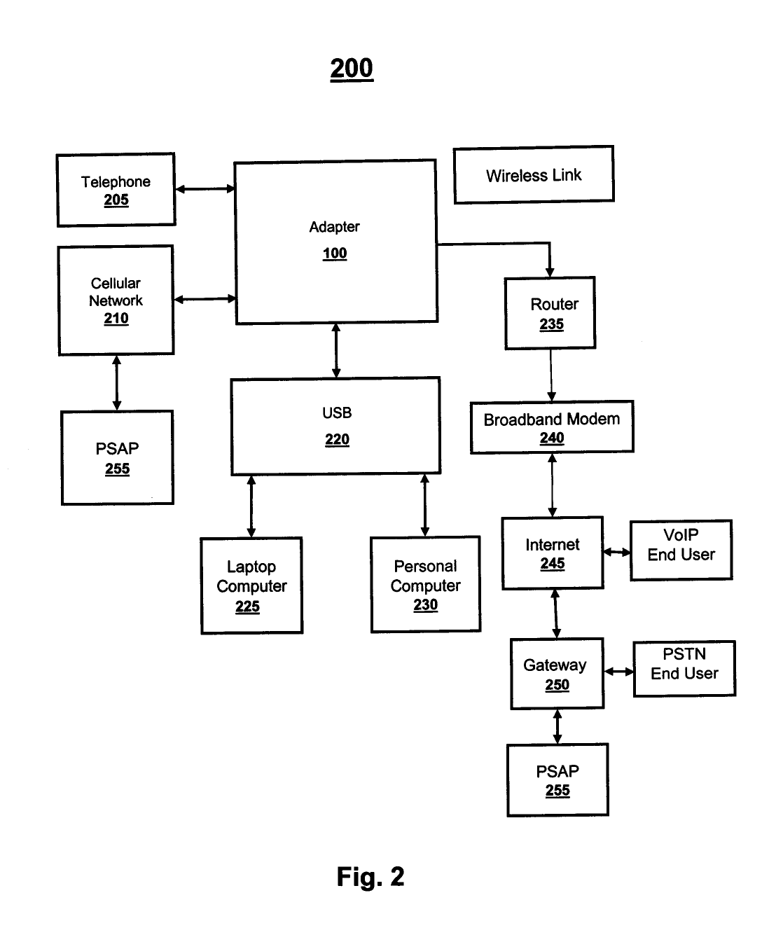

The embodiment shown in FIG. 2 is provided for illustration purposes and not by way of limitation. It will be apparent to one of ordinary skill in the art that the elements that make up the communications network can vary and be optimized for different applications.

FIG. 2 illustrates a communications network 200, according to an embodiment of the invention. The communications network 200 includes a telephone 205, cellular network 210, adapter 100, a connector such as a USB connector 220, laptop computer 225, personal computer 230, router 235, a broadband modem 240, Internet 245, gateway 250, public safety answering point (PSAP) 255, VoIP end-user, and PSTN end-user.

According to an embodiment of the invention, the adapter 100 may include a wireless network card 125 which allows the adapter 100 to wirelessly connect to a wide area network, such as the Internet 245. As shown in FIG. 2, the adapter 100 may transmit digitized voice signals to a router 235. The router 235 is of a kind well known by those of ordinary skill in the art, such as an 802.1 1g router. The router 235 may receive the voice signal and convert it into a packet format for transmission over the Internet 245. Accordingly, the adapter 100 need not be physically connected to the router 235 and therefore does not have to be in close physical proximity to the router 235. Alternatively, the adapter 100 may include a connector such as a USB connector for connecting directly to a laptop or desktop computer. In yet another embodiment, the adapter 100 may include a connector such as a USB connector for connecting directly to a router or broadband modem.

The adapter 100 can receive voice inputs from a telephone 205, or from a laptop computer 225 or personal computer 230. In addition, the adapter 100 can receive voice inputs via a connector such as a USB connector 220.

In yet another embodiment (not shown), the laptop computer 225 or the personal computer 230 may be connected directly to the router 235, which permits connection to the Internet via the broadband modem 240. The computer may also include a wireless network card 125 which allows the computer to wirelessly connect to a wide area network, such as the Internet 245. The computer may transmit digitized voice signals to a router 235. The router 235 is of a kind well known by those of ordinary skill in the art, such as an 802.11g router. The router 235 may receive the voice signal and convert it into a packet format for transmission over the Internet 245. Accordingly, the computer need not be physically connected to the router 235 and therefore does not have to be in close physical proximity to the router 235. Alternatively, the computer may include a connector such as an Ethernet or USB connector for connecting directly to the router 235 or broadband modem 240.

The computer can receive voice inputs from a telephone 205, or from an adapter 100. Alternatively, the computer can receive voice inputs via a connector such as a USB connector 220.

As stated above and with reference to FIG. 1(a), the adapter 100 may include a wireless network card 125. The wireless network card 125 is of a kind known to one of ordinary skill in the art, such 802.11b and 802.11g PCI cards. The wireless network card 125 in the adapter 100 can be configured to transmit the digitized voice data across several different networks. One of ordinary skill in the art can appreciate that there are numerous types of wireless PCI cards allowing access to numerous networks, such as Wi-Fi, Wi-Max, EV-DO and HSPDA and others.

The router 235 is optional. In one embodiment, the router 235 transmits the digitized voice signal to the broadband modem 240. The broadband modem 240 can be a wireless broadband modem and can include a cellular link. In another embodiment, the digitized voice signals may be provided to the broadband modem 240 without an intervening router (not shown). Devices such as routers act as access points, or portals, to a packet switched network, such as the Internet 245. The broadband modem 240 encodes and transmits the digitized voice signal across a packet switched network such as the Internet 245. The broadband modem 240 can be cable modem, DSL modem, or satellite or other wireless broadband links. One of ordinary skill in the art can appreciate that the router 235 could be a stand-alone router for a home user or a server in an enterprise setting.

In one embodiment, the transmitted packetized voice signals are received and decoded and converted to analog or digitized voice signals by a soft phone client running on a remote computer. In another embodiment, the transmitted packetized voice signals are received and decoded and converted to analog or digitized voice signals by a gateway 250 and then sent to a PSTN end user at the far-end.

The adapter 100 also includes a cellular chip 130 which is used for diverting emergency 911 calls from the VoIP system. The CPU 135 in conjunction with the transceiver periodically scans cellular signals from the cellular tower or towers to determine if there is a cellular signal. The transceiver may scan cellular signals at any frequency. In one embodiment, for example, the transceiver may continually scan cellular signals from the cellular tower or towers. In another embodiment, for example, the transceiver may intermittently scan cellular signals. When the adapter 100 detects an emergency call, if the transceiver detected the presence of a cellular signal, then the CPU 135 attempts to initiate two-way communication with PSAP 255 over the cellular network via the cellular chip 130. If it is unsuccessful in establishing two-way communication with PSAP 255, then it will route the call as a VoIP call. If the transceiver did not detect the presence of a cellular signal, then the CPU 135 outputs the call as a VoIP call.

In the event that the emergency call is transmitted over the cellular network, then the PSAP 255 receives the call and processes the call as it would process any other call received over the cellular network. The manner in which these calls are processed is known in the art.

In the event that the call is transmitted as a VoIP call, the broadband modem 240 encodes and transmits the packetized voice signal across a packet switched network such as the Internet 245. In one embodiment, the transmitted packetized voice signals are received at a gateway 250 where they are decoded and converted to analog or digitized voice signals. In one embodiment, the gateway 250 that converts the signal from packetized voice signals to analog or digitized voice signals may be part of the VoIP service provider infrastructure. In another embodiment, the gateway 250 that converts the signal from packetized voice signals to analog or digitized voice signals may be part of the infrastructure of a service provider specializing in emergency communications infrastructure. In either case, the analog or digitized voice signals are then sent to the PSAP 255 in a manner known in the art. In another embodiment, the gateway 250 that converts the signal from packetized voice signals to analog or digitized voice signals may be part of the PSAP infrastructure. In yet another embodiment, if the PSAP is capable of receiving packetized voice signals, then the packetized voice signals are sent directly to the PSAP without conversion to analog or digitized voice signals.

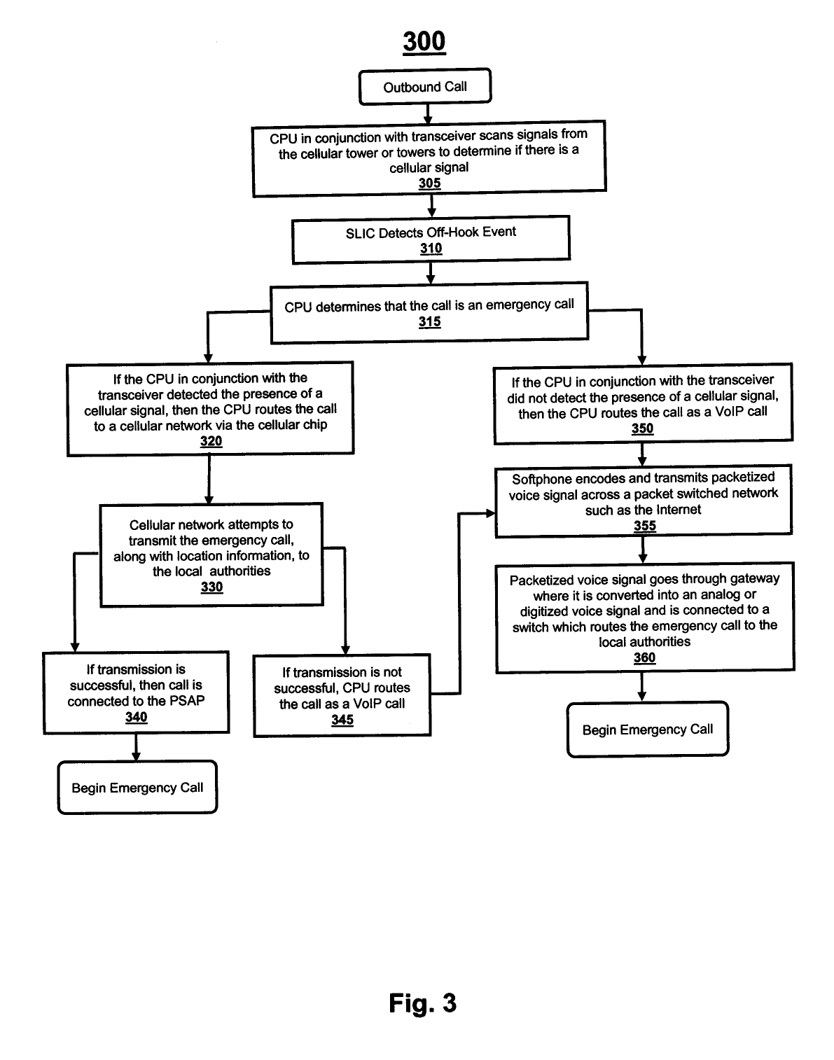

FIG. 3 is a flow diagram illustrating the process of making an emergency call 300, in accordance with an embodiment of the invention. The process 300 is described with respect to the adapter 100 shown in FIGS. 1(a) and 1(b), but may be applied to other systems.

As shown in step 305, the CPU in conjunction with the transceiver is periodically scanning signals from the cellular tower or towers to determine if there is a cellular signal. In step 310, the SLIC 140 detects an off-hook event and notifies the CPU 135. The DSP (not shown) embedded in the CPU 135 awaits the receipt of the first DTMF digit from the handset. In step 315, the CPU 135 determines that the call is to be an emergency call. This is determined by the user inputting known DTMF digits according to emergency services, such as 911 call, 311 call, and other services known to one of ordinary skill in the art.

In step 320, if the CPU in conjunction with the transceiver detected the presence of a cellular signal in step 305, then the CPU 135 routes the call to a cellular network via the cellular chip 130. The cellular network chip 130 (or cellular network circuit) acts to modulate the voice signal in a manner which allows it to be transmitted over a cellular network. It will be apparent to one of ordinary skill in the art that there are numerous ways to implement a cellular network, such as GSM, CDMA, UMTS and the embodiment provided is not meant to limit the scope of the invention.

In step 330, the cellular network attempts to transmit the emergency call to the appropriate public safety answering point (PSAP) in a way known to one of ordinary skill in the art. By way of example, the cellular network determines the location of the caller, as it does for other cellular callers, and transmits location information to the PSAP along with the actual call. If the transmission of the call over the cellular network is successful, the call is connected to the PSAP in step 340, and the emergency call begins over the cellular network.

If the transmission of the call over the cellular network is not successful, then the CPU routes the call as a VoIP call in step 345. In step 355, the softphone encodes and transmits the packetized voice signal across a packet switched network such as the Internet. In step 360, the signal goes through a gateway, where it is converted into an analog or digitized voice signal and connected to a switch which routes the emergency call to the local authorities. In other embodiments of the invention (not shown), the packetized signal may go directly to the local authorities without going through a gateway.

In further embodiments of the invention, emergency call re-routing functionality may be placed in other components of a telephone system. For example, a cellular interface and re-routing functionality could be implemented within a telephone handset, within a specialized adaptor coupled to a handset, or within a conventional personal computer coupled in some manner to a handset, headset, or other audio system.

In step 350, if the CPU in conjunction with the transceiver did not detect the presence of a cellular signal in step 310, then the CPU routes the call as a VoIP call. In step 355, the softphone encodes and transmits the packetized voice signal across a packet switched network such as the Internet. In step 360, the signal goes through a gateway, where it is converted into an analog or digitized voice signal and connected to a switch which routes the emergency call to the local authorities. In other embodiments of the invention (not shown), the packetized signal may go directly to the local authorities without going through a gateway.

In addition, in further embodiments of the invention, determining whether there is a cellular signal may take place in other components of a telephone system. For example, the signal strength determination could be implemented within a telephone handset, within a specialized adaptor coupled to a handset or within a conventional personal computer coupled in some manner to a handset, headset or other audio system.

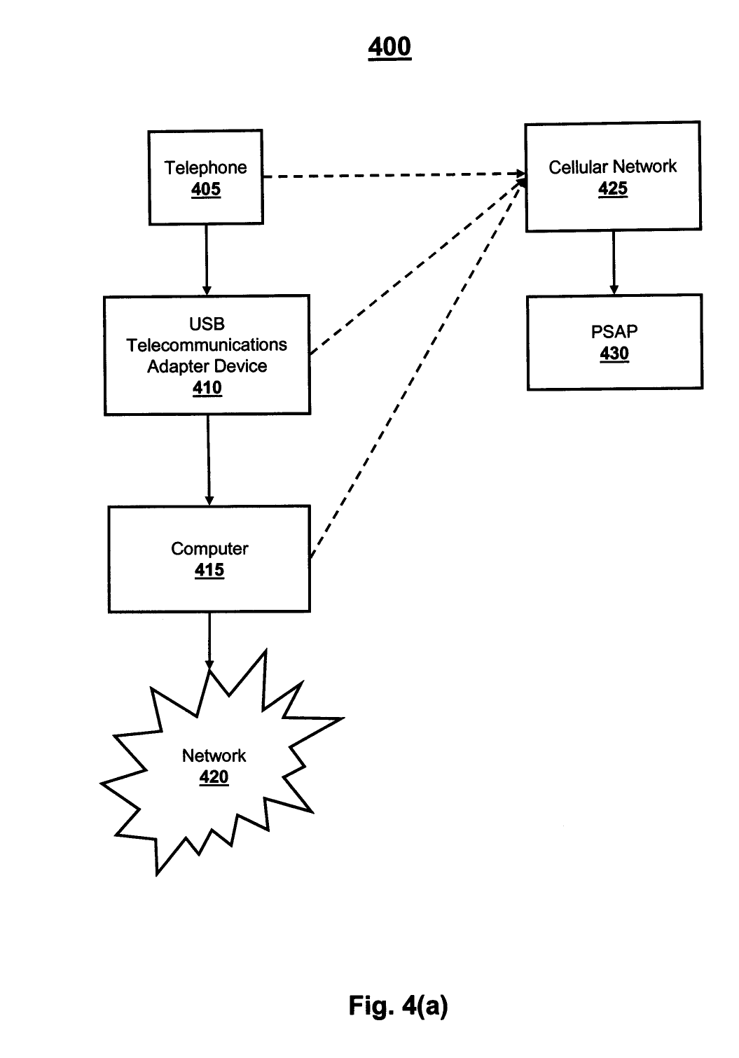

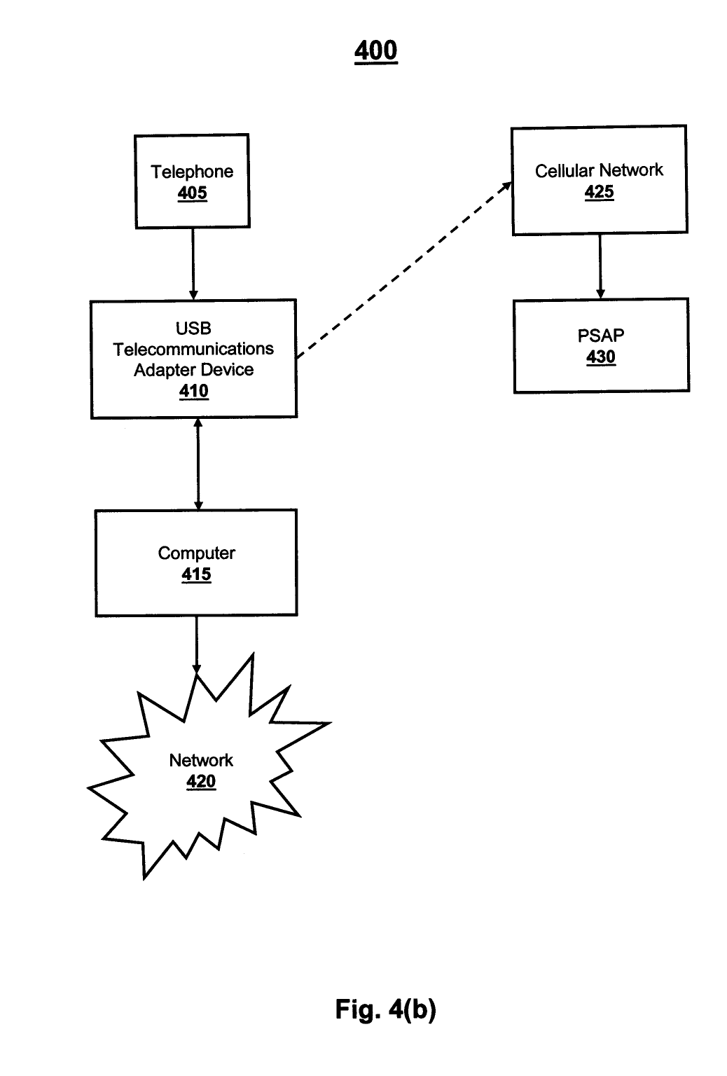

FIGS. 4(a) and 4(b) may be used to explain several embodiments of the invention. FIG. 4(a) depicts a communications network 400, including a telephone 405, USB adapter 410, computer 415, and packet-switched network 420, such as the Internet. In particular, the telephone 405 is coupled to the computer 415 via the USB adaptor 410, but that specific interface is included only by way of example and is not necessary or important to the invention. For example, the telephone 405 may itself be a USB phone and therefore capable of connecting directly to the computer 415 via a USB interface, making an intervening adaptor unnecessary. Other communication protocols may also be used in addition to or instead of USB.

In the system of FIG. 4(a), typical calls using the telephone 405 would be routed through the adaptor 410 and computer 415 to a packet-switched network 420 using VoIP technology. Since emergency calls over such a system present problems, as described above, the present invention provides for the inclusion of emergency call re-routing functionality over a cellular interface, or over some other interface designated for emergency situations. Specifically, either the telephone 405, the adaptor 410, or the computer 415 may include a cellular (or emergency) interface, such as a cellular chip or PCMCIA card, and re-routing intelligence, such as specialized application software. The re-routing intelligence, which may be on a CPU separate from the cellular interface or incorporated therein, is capable of detecting that an emergency call is being made, by detecting that “911” has been dialed for example, and (1) re-routing the call over the cellular interface to a cellular network 425 if two-way communication is possible over the cellular network 425, or (2) re-routing the call over the VoIP network if such two-way communication is not possible. The determination of whether two-way communication is possible is made by scanning cellular signals from the cellular tower or towers and if a cellular signal is detected, then attempting two-way communication over the cellular network. In addition, if a cellular signal is detected, the re-routing intelligence will determine whether the attempted two-way communication over the cellular network was successful. If the attempted two-way communication over the cellular network was not successful, then the re-routing intelligence may re-route the call over the VoIP network.

Note that the cellular interface, the transceiver, and the re-routing intelligence may be included in the phone 405, in the adaptor 410, or in the computer 415. Also note, however, that none of these components need to be located in the same physical device as any of the others. For example, the re-routing intelligence may re-route an emergency call by signaling a separate component that actually includes the cellular interface. In one embodiment, the telephone 405 is an ordinary telephone, while the adaptor 410 includes the cellular interface and the transceiver and the computer 415 includes the re-routing intelligence. In such a system, the re-routing intelligence of the computer 415 detects that an emergency call has been made and checks for a cellular signal. By way of example, the computer itself may detect that an emergency call has been made and check for the presence of a cellular signal, or it may signal the adaptor 410 to check for the presence of a cellular signal. Depending on the implementation, the computer 415 and/or the adaptor must be provided with the capability to detect and respond to such signaling and also to re-route calls over the cellular interface.

In yet another embodiment, the cellular interface is disposed within the telephone 405 while the re-routing intelligence is disposed within the computer 415. In this embodiment, a similar detection and signaling process occurs between the computer and the phone, as will be apparent to those of ordinary skill in the art. Note also that in such an embodiment a separate adaptor component is unnecessary. In those embodiments where the re-routing intelligence and emergency interface are disposed within computer 415, neither telephone 405 nor adaptor 410 would be necessary, particularly where the computer 415 includes all the usual functionality of a normal handset as would be understood by those of ordinary skill in the art.

FIG. 4(b) shows the communications network 400 according to a preferred embodiment of the invention. In the system of FIG. 4(b), the adaptor 410 includes a cellular (or emergency) interface including a transceiver, such as a cellular chip or PCMCIA card along with re-routing intelligence, as indicated above.

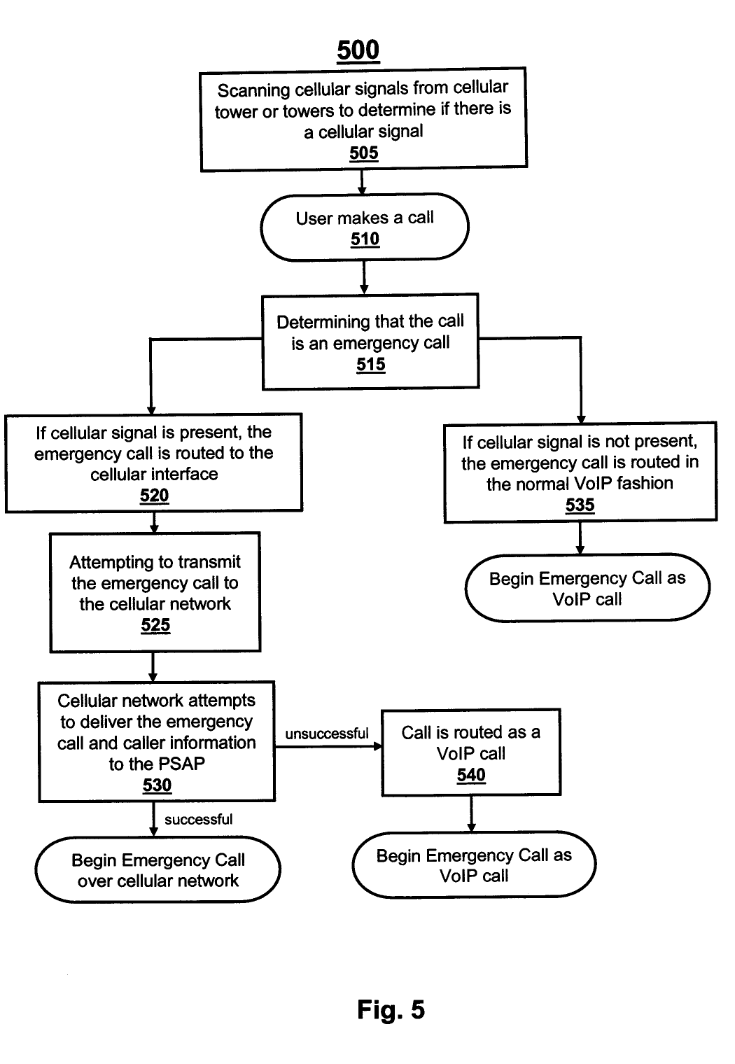

FIG. 5 depicts a flow diagram of re-routed and non-re-routed emergency calls in accordance with certain aspects of the invention 500. In step 505, the transceiver is periodically scanning cellular signals from the cellular tower or towers to determine if there is a cellular signal. In step 510, the user make a call. In step 515, the re-routing intelligence determines if the call is an emergency call. If not, the call is routed via a packetized signal as, for example, a VoIP call (not shown). If the transceiver did not detect a cellular signal in step 505, then the emergency call is routed in the normal VoIP fashion in step 535. If the transceiver did detect a cellular signal in step 505, then the emergency call is re-routed to the emergency interface, which in this example is a cellular interface, i.e. cellular chip, in step 520. As noted above, the cellular interface may be disposed in any of various system components and the re-routing may entail certain signaling between components. As shown in step 525, once the call has been re-routed, there is an attempt to transmit the call over the cellular interface to a cellular network, which in turn transmits the call and special service information, including caller location information, to a PSAP, in a conventional manner, as shown in step 530.

If either the attempt to re-route the emergency call to the emergency interface fails (not shown) or the attempt to transmit the call over the cellular interface to a cellular network fails, then the call is routed in the normal VoIP fashion in step 540.

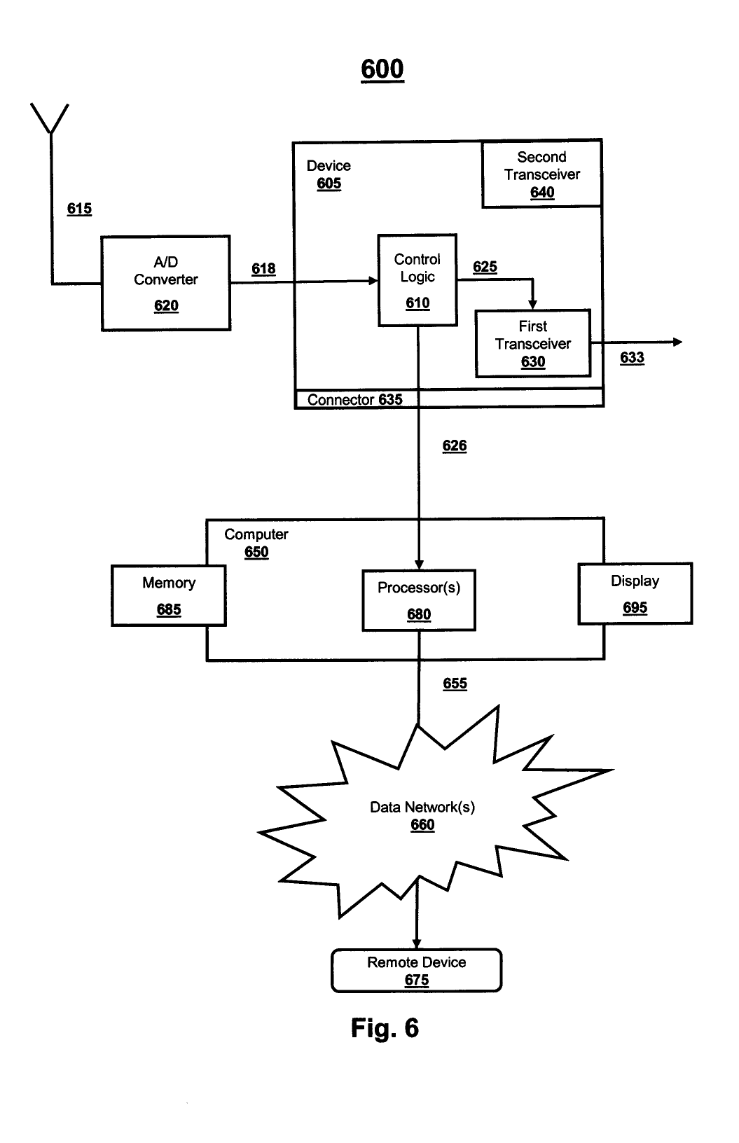

FIG. 6 shows a computer system 600 including a device 605 for use with a computer 650. The device 605 includes control logic 610, such as a controller, a dedicated processor and/or a CPU that receives a first signal, such as an analog or digital signal. The analog signal may be a dual-tone multi-frequency based signal. If the control logic 610 receives an analog signal, it may have some associated analog to digital converter to convert the analog signal to a digital signal for processing. Also, if the first signal 618 is a digital signal 618, it may have been converted from an analog signal 615 via the use of an analog to digital converter 620, which could be included in the device 605. Also, the reference to a signal herein may include a signal incorporating multiple signals.

In one embodiment, the CPU in conjunction with the first transceiver 630 periodically scans cellular signals from the cellular tower or towers to determine if there is a cellular signal. The control logic 610 evaluates the first signal 618 to determine whether the first signal 618 corresponds to an emergency call, which may be an emergency “911” call. The control logic 610 outputs a second signal 625 if it is determined that the first signal 618 corresponds to an emergency call and that a cellular signal is present, as described below. The second signal 625 may be identical to the first signal 618 or merely derived from the first signal 618.

The first transceiver 630 receives the second signal 625 from the control logic 610 and the first transceiver attempts to transmit a radio signal 633 to establish a two-way communication channel corresponding to the emergency call upon receipt of the second signal 625. The control logic 610 will therefore only send the second signal 625 to the first transceiver 630 if a cellular signal is detected by the first transceiver. The device 605 will then be permitted to attempt to make an emergency services call through a two-way communication channel that may include a commercial mobile radio service (“CMRS”). In an alternative embodiment, the transceiver does not periodically scan for cellular signals for all emergency calls and the second signal will be sent to the transceiver which will attempt to transmit a radio signal 633 to establish a two-way communication channel corresponding to the emergency call.

The control logic 610 may also determine if the first signal 615 corresponds to an outbound call other than an emergency call, if a cellular signal is not present, or if the attempt to transmit the emergency call using the cellular network fails. In any of these cases, the control logic provides a third signal 626 to the computer 650. The computer 650 then facilitates the transfer of a voice communication 655, which is a packetized signal, corresponding to the outbound call, via one or more data networks 660. The outbound call may be implemented as a VoIP call. The voice communication 655 may include at least one packet of data (not shown) which may also include an address (not shown) corresponding to a remote device 675 that is to receive the packet of data.

The device 605 may include a connector 635 that couples the device to the computer 650. The connector 635 may be a USB connector or an Ethernet or other connector. The device 605 may also be wirelessly coupled to a computer via, for example, a second transceiver 640.

The control logic 610 and/or the first transceiver 630 may be implemented on an application specific integrated chip (not shown), which will greatly facilitate its use in a miniature device. The control logic 610 and/or first transceiver 630 may be implemented on a card (e.g., a PCMCIA card) (not shown) to be inserted within a slot of the computer 650. Alternatively, the control logic 610 and/or first transceiver 630 may be built into the computer 650, obviating the need for a separate device 605 or simplifying the device 605 by having only the control logic 610 or first transceiver 630 located therein. In a streamlined implementation of a preferred embodiment, the device 610 and/or computer 650 may be implemented without a subscriber identity module or a connector for a subscriber identity module.

The computer 650 includes one or more processors 680 (e.g., CPU), controllers (not shown) and/or control logic (not shown) coupled to memory 685, such as a RAM, a ROM, an SDRAM, an EEPROM, a flash memory, a hard drive, an optical drive and/or a floppy drive. The control logic 610 of the device 605 may also have such memory associated with it to store software and/or data used by the software to implement the present invention.

The computer 650 may be accessible to a user directly or indirectly via one or more data networks 660, such as a local area network, wide area network, wireless network, or the Internet. If the computer 650 is directly accessible, the user may interact with the computer 650 via input output devices (not shown), such as a keyboard, mouse, trackball, or touch screen. In addition, the computer 650 may have a display 695, such as a monitor, LCD display, or plasma display, which displays information to the user. The computer 650 may also be coupled to a printer (not shown) for printing information.

The software application code may be stored in a computer readable medium such as memory. In one embodiment, the computer 650 may store in a computer readable media, such as the memory 685, the software (and corresponding data) that is used to implement an embodiment of the present invention. However, other computer readable media may be employed as well, e.g., a RAM, a ROM, an SDRAM, an EEPROM, a flash memory, a hard drive, an optical drive and/or a floppy drive. Also stored in the memory 685 of the computer 650 are the data relied upon by the software application code of the present invention. The software application code may also be implemented in hardware via a dedicated device incorporating control logic or a controller, for example. The software application code includes software instructions to be executed by the processor 680 or some other processor which is separate from the CPU of the computer 650. Alternatively, the software may be executed by a processor, a controller, or control logic on the device 605. In other embodiments, the software (and corresponding data) that is used to implement the invention may be stored in memory on the device.

In execution, the software application code causes the processor 680 to receive a first signal (e.g., the first signal 618) and evaluate the first signal to determine whether the first signal corresponds to an emergency call. The software application code may do so by, for example, evaluating a signal representing the frequencies of one or more signals corresponding to key presses in a DTMF implementation. Accordingly, if key presses corresponding to “9”, “1”, “1” are associated with an emergency call, then it shall be determined whether a signal includes an indicia of frequencies corresponding to those key presses to identify an emergency call. The software application code also causes the processor 630 to output a second signal (e.g., the second signal 625) to a first transceiver (e.g., the first transceiver 630) if it is determined that the first signal corresponds to an emergency call and that a cellular signal is present. The first transceiver is capable of receiving the second signal from the processor and transmitting a radio signal (e.g., the radio signal 633) to establish a two-way communication channel corresponding to the emergency call upon receipt of the second signal. The emergency call may be made to, for example, an emergency operator.

In execution, the software application code may also cause the processor 680 to determine that the first signal corresponds to an outbound call other than the emergency call, that a cellular signal is not present, or that an attempted connection over the cellular network failed. In any of these cases, the processor 680 facilitates the transfer of a voice communication (e.g., the voice communication 655, which may be a digital signal) corresponding to the outbound call via one or more data networks 660. In the case of detecting non-emergency calls, this may be accomplished in a manner similar to that described above in connection with the detection of an emergency call in a DTMF based implementation, except that a signal is evaluated to determine that it does not contain an indicia of frequencies corresponding to those key presses which are associated with an emergency call. As noted above, the outbound call may be implemented as a VoIP call and the voice communication may include at least one packet of data which may include an address corresponding to a remote device 1150 that is to receive the packet of data.

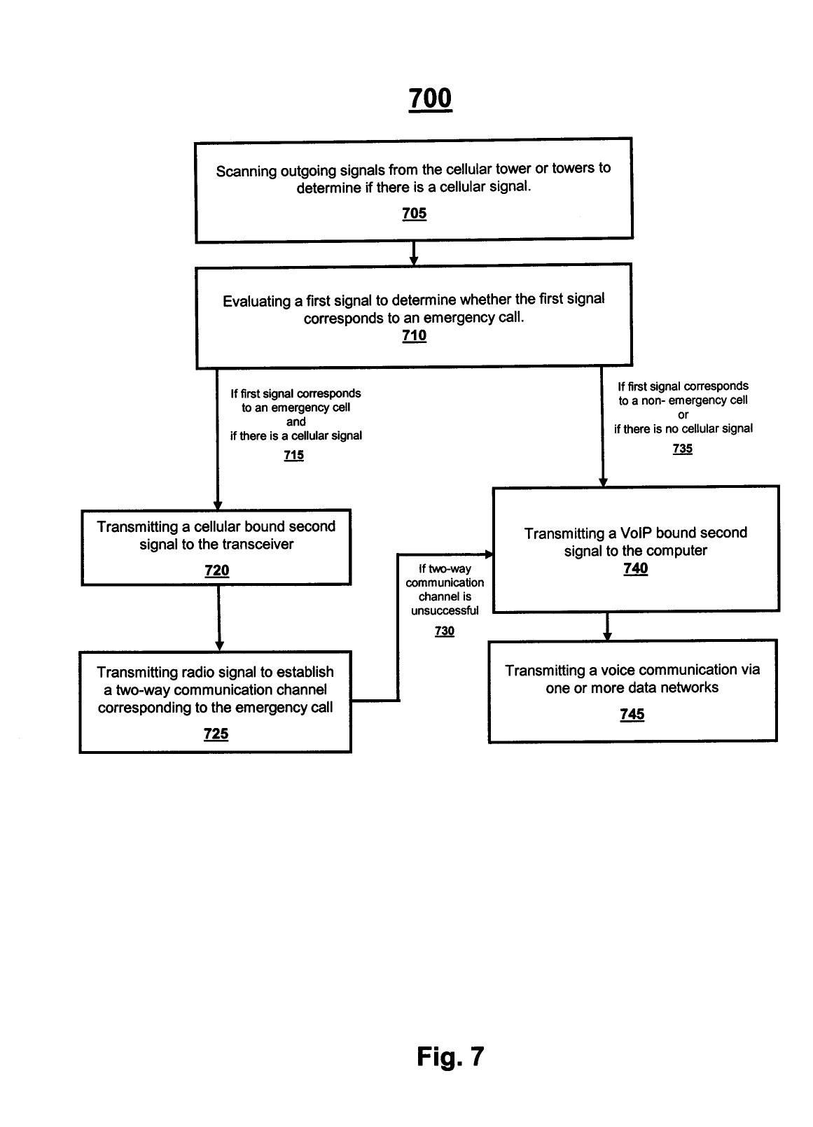

FIG. 7 depicts a method for making a telephone call 700 according to an embodiment of the invention. The method includes step 705, periodically scanning outgoing cellular signals from the cellular tower or towers to determine if there is a cellular signal. Next is step 710, evaluating, in a computer or a device (for use with a computer), a first signal (e.g., the first signal 615) to determine whether the first signal corresponds to an emergency call, such as an emergency “911” call. The first signal may be an analog or digital voice signal. The analog signal may be a dual-tone multi-frequency based signal. If the first signal is a packetized signal, it may have been converted from an analog or digitized voice signal via the use of an analog to digital converter (e.g., the analog to digital converter 620). Thereafter, if the first signal corresponds to an emergency call and there is a cellular signal in step 715, then the control logic transmits a second signal to the transceiver in step 720 and the transceiver (e.g., the first transceiver 630, which may or may not be located in the device 605) transmits a radio signal to establish a two-way communication channel corresponding to the emergency call in step 725. The two-way communication channel may include a commercial mobile radio service (“CMRS”).

If the two way communication channel is unsuccessful 730, then the the control logic transmits a third signal to the computer in step 740. Likewise, if after step 710, it is determined that the first signal corresponds to a non-emergency call or if there is no cellular signal 735, then the the control logic transmits a third signal to the computer in step 740. Thereafter, in step 745, a voice communication is transmitted via a data network (e.g., the data network 660), the voice communication (which may be a packetized signal) corresponding to the outbound call. As noted above, the outbound call may be implemented as a VoIP call and the voice communication may include at least one packet of data and an address corresponding to a remote device (e.g., the remote device 675) that is to receive the packet of data.

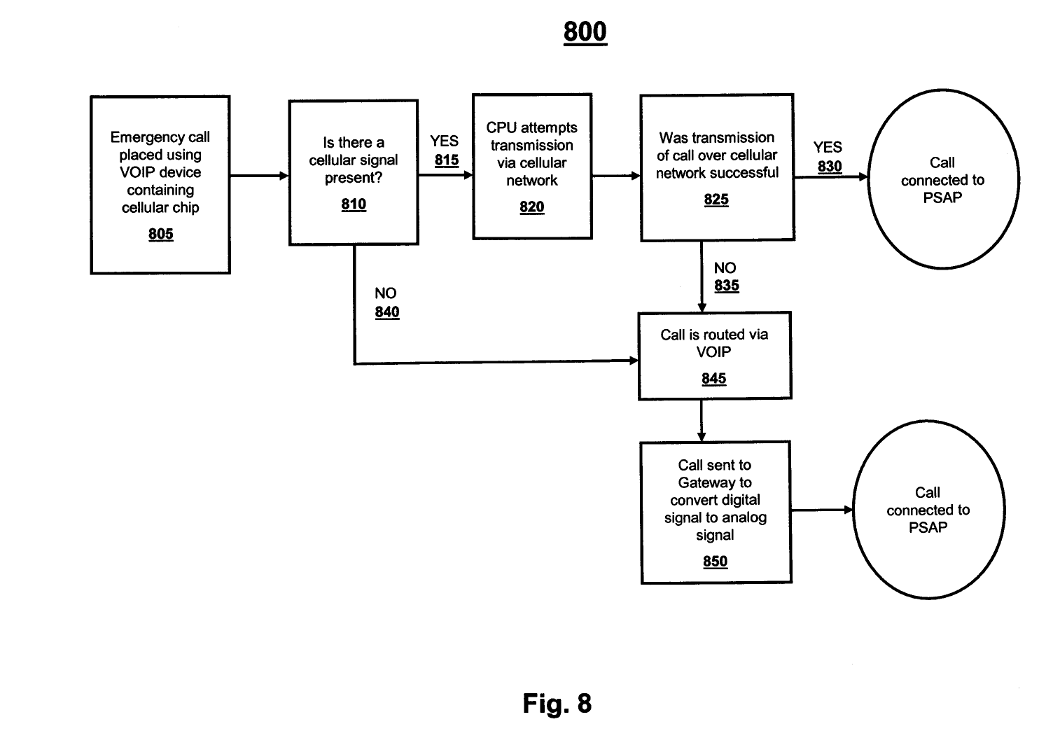

FIG. 8 depicts the transmission of an emergency call 800 according to one embodiment of the invention. In step 805, an emergency call is placed using a VoIP device containing a cellular chip. In step 810, it is determined whether a cellular signal is present. This determination may be based on whether the CPU in conjunction with a transceiver detects the presence of a cellular signal from the cellular tower or towers (not shown). The CPU in conjunction with the transceiver may attempt to detect the presence of a cellular network before step 805, during step 805, after step 805, or any combination thereof. If is it determined that there is a cellular network present, then the CPU attempts transmission of the call over the cellular network 815. In step 825, the CPU determines if the transmission of the call over the cellular network was successful. If the transmission is successful 830, the call is connected to the PSAP using cellular technology. Likewise, if it is determined that a cellular network is not present, then the call is routed as a VoIP call in step 845. If the transmission is not successful, the call is routed—as a VoIP call in step 845. In step 850, the VoIP call is sent to a gateway where the call is then connected to the PSAP. In some instances, the gateway may convert the call from packetized voice signals to analog or digitized voice signals. In other cases, it may remain as packetized voice signals through to the PSAP.

When the emergency call is routed as a VoIP call, the conversion from packetized voice signals to analog or digitized voice signals, if necessary, may occur at a gateway of the VoIP service provider, or a gateway of a service provider that specializes in emergency call handling, or a gateway at the PSAP site, or any other gateway capable of converting packetized voice signals to analog or digitized voice sign.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims, in which all terms are meant in their broadest reasonable sense unless otherwise indicated therein.

We claim:

1) A device for use with a computer, said device comprising: control logic that receives a first signal corresponding to an emergency call, said control logic implementing said emergency call as one of a cellular-based call or a VoIP call, said control logic implementing said emergency call as a cellular-based call via a cellular network if two-way communication can be established with a remote device via said cellular network; said control logic implementing said emergency call as a VoIP call if said two-way communication can not be established with a remote device via said cellular network.

2) The device of claim 1, wherein said control logic determines whether said two-way communication can be established.

3) The device of claim 2, wherein said control logic determines whether said two-way communication can be established by evaluating whether a cellular signal is present.

4) The device of claim 3, wherein said evaluating is accomplished by employing a first transceiver to scan for cellular signals from one or more cellular towers.

5) The device of claim 1, wherein a first transceiver coupled to said control logic transmits a radio signal to said remote device in an attempt to establish said two-way communication.

6) The device of claim 2, wherein a first transceiver coupled to said control logic transmits a radio signal to said remote device in an attempt to establish said two-way communication.

7) The device of claim 6, wherein said control logic determines whether said two-way communication can be established by attempting to communicate with said remote device at least once, said two-way communication being established if said attempt is successful, said two-way communication not being established if said attempt is unsuccessful.

8) The device of claim 2, wherein said control logic determines whether said two-way communication can be established by attempting to communicate with said remote device at least once, said two-way communication being established if said attempting is successful, said two-way communication not being established if said attempting is unsuccessful.

9) The device of claim 1, wherein said device is incorporated into said computer.

10) The device of claim 1, wherein said control logic determines if said first signal corresponds to an emergency call.

11) A processor program product for use in a device having a processor for executing software instructions, said device being for use with a computer, said processor program product comprising:
a processor usable medium having processor readable program code embodied therein for causing said processor to receive a first signal corresponding to an emergency call; for causing said processor to implement an emergency call as one of a cellular-based call or a VoIP call; said processor to implement said emergency call as a cellular-based call via a cellular network if two-way communication can be established with a remote device via said cellular network; said processor to implement said emergency call as a VoIP call if said two-way communication can not be established with a remote device via said cellular network.

12) The processor program product of claim 11, wherein said processor readable program code causes said processor to determine whether said two-way communication can be established.

13) The processor program product of claim 12, wherein said processor readable program code causes said processor to determine whether said two-way communication can be established by evaluating whether a cellular signal is present.

14) The processor program product of claim 13, wherein said evaluating is accomplished by employing a first transceiver to scan for cellular signals from one or more cellular towers.

15) The processor program product of claim 11, wherein said processor readable program code causes a first transceiver coupled to said processor to transmit a radio signal to said remote device in an attempt to establish said two-way communication.

16) The processor program product of claim 12, wherein said processor readable program code causes a first transceiver coupled to said processor to transmits a radio signal to said remote device in an attempt to establish said two-way communication.

17) The processor program product of claim 16, wherein said processor readable program code causes said processor to determine whether said two-way communication can be established by attempting to communicate with said remote device at least once, said two-way communication being established if said attempt is successful, said two-way communication not being established if said attempt is unsuccessful.

18) The processor program product of claim 12, wherein said processor readable program code causes said processor to determine whether said two-way communication can be established by attempting to communicate with said remote device at least once, said two-way communication being established if said attempting is successful, said two-way communication not being established if said attempting is unsuccessful.

19) The processor program product of claim 11, wherein said processor readable program code causes said processor to determine if said first signal corresponds to an emergency call.

20) A method for making a telephone call comprising:
receiving a first signal corresponding to an emergency call;
implementing said emergency call as one of a cellular-based call or a VoIP call, said implementing said emergency call as a cellular-based call via a cellular network if two-way communication can be established with a remote device via said cellular network; said implementing said emergency call as a VoIP call if said two-way communication can not be established with a remote device via said cellular network.

21) The method of claim 20, further comprising determining whether said two-way communication can be established.

22) The method of claim 21, wherein said determining is established by evaluating whether a cellular signal is present.

23) The method of claim 22, wherein said evaluating is accomplished by employing a first transceiver to scan for cellular signals from one or more cellular towers.

24) The method of claim 20, wherein a first transceiver coupled to said control logic transmits a radio signal to said remote device in an attempt to establish said two-way communication.

25) The method of claim 21, wherein a first transceiver coupled to said control logic transmits a radio signal to said remote device in an attempt to establish said two-way communication.

26) The method of claim 25, wherein said determining whether said two-way communication can be established is accomplished by attempting to communicate with said remote device at least once, said two-way communication being established if said attempt is successful, said two-way communication not being established if said attempt is unsuccessful.

27) The method of claim 21, wherein said determining whether said two-way communication can be established is accomplished by attempting to communicate with said remote device at least once, said two-way communication being established if said attempting is successful, said two-way communication not being established if said attempting is unsuccessful.

28) The method of claim 20, further comprising the step of determining if said first signal corresponds to an emergency call.
